(19) United States
(12) Patent Application Publication
(10) Pub. No.: US 2013/0086485 A1
(43) Pub. Date: Apr. 4, 2013

(54) Bulk Categorization

(71) Applicant: Michael James Ahiakpor, San Francisco, CA (US)

(72) Inventor: Michael James Ahiakpor, San Francisco, CA (US)

(21) Appl. No.: 13/250,511

(22) Filed: Sep. 30, 2011

(51) Int. Cl. G06F 3/01; G06F 15/16

(52) U.S. Cl. 715/752

(57) ABSTRACT

Bulk categorization techniques are described for messages. In one or more implementations, an input is received that selects one or more messages accessible via a user account. A first option is output in a user interface that is selectable to categorize each message from a sender of the one or more messages in the user account. A second option is output in the user interface that is selectable to categorize each message subsequently received from the sender by the user account.

### BACKGROUND

The amount of messages with which a typical user may interact in a given day is ever increasing. For example, a user may receive a multitude of emails that vary in an amount of importance to a recipient of the emails. The user, for instance, may receive work emails and personal emails in an account. The user may also receive emails that are sent periodically from a sender that may have varying degrees of interest to the user, such as newsletters, offers for sale, and so on.

However, traditional techniques that were employed to interact with the emails generally did not differentiate between these emails. Consequently, a user was often forced to navigate through each of the emails using traditional techniques to locate a particular email of interest, which could be both time consuming and frustrating to the user especially when considering the vast number of emails and other messages even a typical user may receive in a day.

### SUMMARY

Bulk categorization techniques are described for messages. In one or more implementations, an input is received to select one or more messages accessible via a user account. A first option is output in a user interface that is selectable to categorize each message from a sender of the one or more messages in the user account. A second option is output in the user interface that is selectable to categorize each message subsequently received from the sender by the user account.

In one or more implementations, an option is exposed in a user interface to specify a category in which to place one or more messages from a specified sender that are currently available via a user account. Responsive to receipt of an indication that the option is selected for a specified sender and specified category, messages are categorized in the user account for the specified sender in the specified category.

In one or more implementations, one or more inputs are received to create a rule, for a user account, that specifies a category in which to place messages associated from a specified sender. The rule is used to categorize subsequent messages in the specified category that are received by the user account from the specified sender.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ bulk categorization techniques.

FIG. 2 is an illustration of a user interface in an example implementation that exposes functionality to categorize one or more messages from one or more senders.

FIG. 3 is an illustration of a user interface in an example implementation that exposes an option to categorize subsequent messages received from a sender in a user account.

FIG. 4 is a flow diagram depicting a procedure in an example implementation in which an option is exposed to categorize messages received from a sender.

FIG. 5 is a flow diagram depicting a procedure in an example implementation in which a rule is created to categorize messages from a specified sender.

FIG. 6 is a flow diagram depicting a procedure in an example implementation in which options are output to categorize each message from a sender as well as subsequent messages received from the sender.

FIG. 7 illustrates an example system that includes the computing device as described with reference to FIG. 1.

FIG. 8 illustrates various components of an example device that can be implemented as any type of computing device as described with reference to FIGS. 1, 2, and 7 to implement embodiments of the techniques described herein.

### DETAILED DESCRIPTION

Overview

Users may utilize messaging (e.g., email, texts, MMS, instant messages, and so on) as a primary means of communication. Because of this, however, even a typical user may receive a multitude of different messages from a wide variety of different sources in a given day, which may make interaction with the messages difficult using conventional techniques.

Bulk categorization is described. In one or more implementations, techniques are described that are usable to categorize messages from a sender. This may include each of the current messages in a user's account as well as messages that are received at a later time. Further, these techniques may be used for a plurality of different senders simultaneously. For example, a user may select a variety of different messages and select an option to categorize the messages into one or more categories for the senders of the messages. In this example, each of the current messages from the senders in the user account may then be categorized accordingly. Further, an option may be output that is selectable to create a rule such that future messages from the senders may be similarly categorized. In this way, a user may efficiently interact and manage a multitude of messages, further discussion of which may be found in relation to the following figures.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

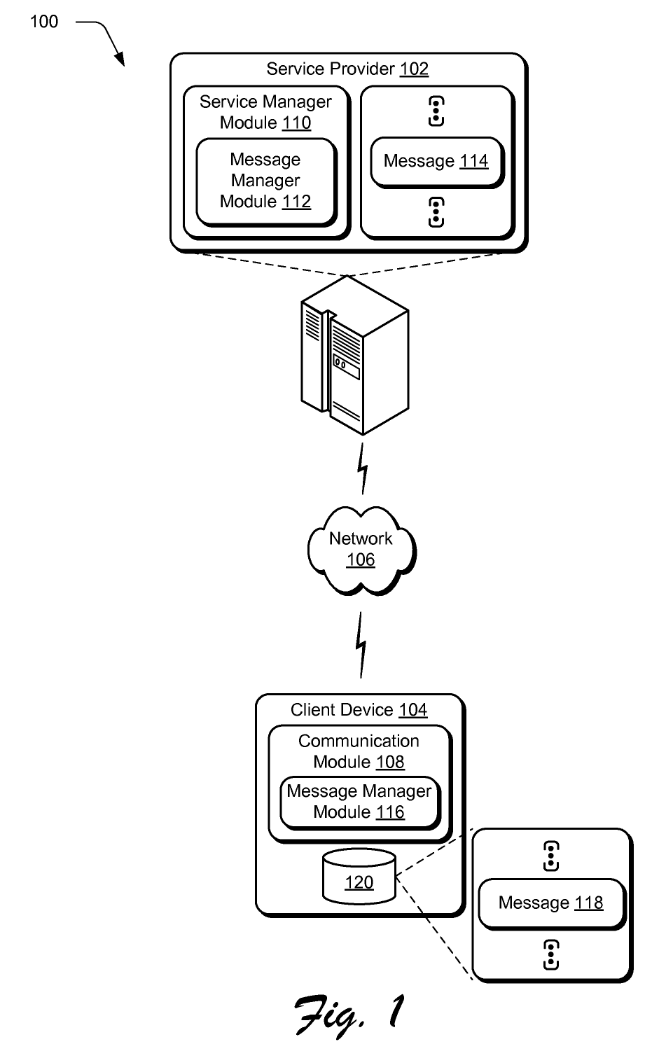

FIG. 1 is an illustration of an environment 100 in an example implementation that is operable to employ techniques described herein. The illustrated environment 100 includes a service provider 102 that is communicatively coupled to a client device 104 via a network 106. The service provider 102 and the client device 104 may be implemented using a wide variety of computing devices.

For example, a computing device may be configured as a computer that is capable of communicating over the network 106, such as a desktop computer, a mobile station, an entertainment appliance, a set-top box communicatively coupled to a display device, a wireless phone, a game console, a server, and so forth. Thus, the computing device may range from full resource devices with substantial memory and processor resources (e.g., servers, personal computers, game consoles) to a low-resource device with limited memory and/or processing resources (e.g., traditional set-top boxes, hand-held game consoles). Additionally, although a single computing device is shown (e.g., a server for the service provider 102), the computing device may be representative of a plurality of different devices, such as multiple servers utilized by a business to perform operations (e.g., a server farm), a remote control and set-top box combination, an image capture device and a game console configured to capture gestures, and so on.

A computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via the network 106. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The client device 104 is further illustrated as including a communication module 108. The communication module 108 is representative of functionality of the client device 104 to communicate via the network 106, such as with the service provider 102. For example, the communication module 108 may incorporate browser functionality to navigate the network 106, may be configured as a dedicated application having network access functionality, and so on.

The service provider 102 is illustrated as including a service manager module 110, which is representative of functionality to provide and manage access to one or more network services via the network 106. The service manager module 110, for instance, may incorporate revenue techniques to collect revenue for provision of the service, such as directly (e.g., for a fee), on a subscription basis, indirectly through inclusion of one or more advertisements, and so on.

One example of a service is illustrated through inclusion of a message manager module 112. The message manager module 112 is representative of functionality of the service provider 102 to manage communication of one or more messages 114. The messages 114, for instance, may be formed through interaction with the message manager module 112 by the client device 104 for communication to another user via a user account.

The messages 114 may also be representative of messages received by the service provider 102 to be communicated via user accounts associated with the service provider 102. The service provider 102, for instance, may receive a message 114 from another service provider and store that message in association with a user account. A user may then access the user account of the service provider 102 to gain access to the message 114, such as by using the communication module 108 of the client device 104. A variety of different messages 114 may be managed by the service provider 102, such as emails, SMS, MMS, instant messages, and other messages capable of being communicated electronically via the network 106 as described in the communication techniques section below.

Functionality of the message manager module 112, however, is not limited to implementation by the service provider 102. As such, the message manager module may be implemented by a variety of different entities, such as a third-party entity, by the client device 104 itself which is illustrated as inclusion of a message manager module 116 to manage messages 118 in storage 120 that is local to the client device 104, and so on. Therefore, although operation of the message manager module 112 is described at the service provider 102, this operation is not so limited and may be distributed throughout the environment 100 as well as other environments.

The message manager module 112 may manage the messages 114 in a variety of ways. For example, the message manager module 112 may expose functionality that may be used to classify messages 114 into respective categories. The categories may then be leveraged to improve user interaction with the messages 114 by the client device 104. For example, the message manager module 112 may expose categories via a user interface that is output by the client device 104, e.g., using browser functionality of the communication module 108. The user interface may include a variety of different categories, such as newsletter, transactions, alerts, social notifications, travel, finance (e.g., confirmations and receipts), and so on.

Conventionally, a user was forced to select a particular message and then manually specify a category in which the message was to be categorized. In order to categorize more than one message using conventional techniques, a user entered one or more keywords (e.g., a sender's name) to perform a search to locate messages from that sender. The user then selected each of the messages and specified a category in which to place the messages.

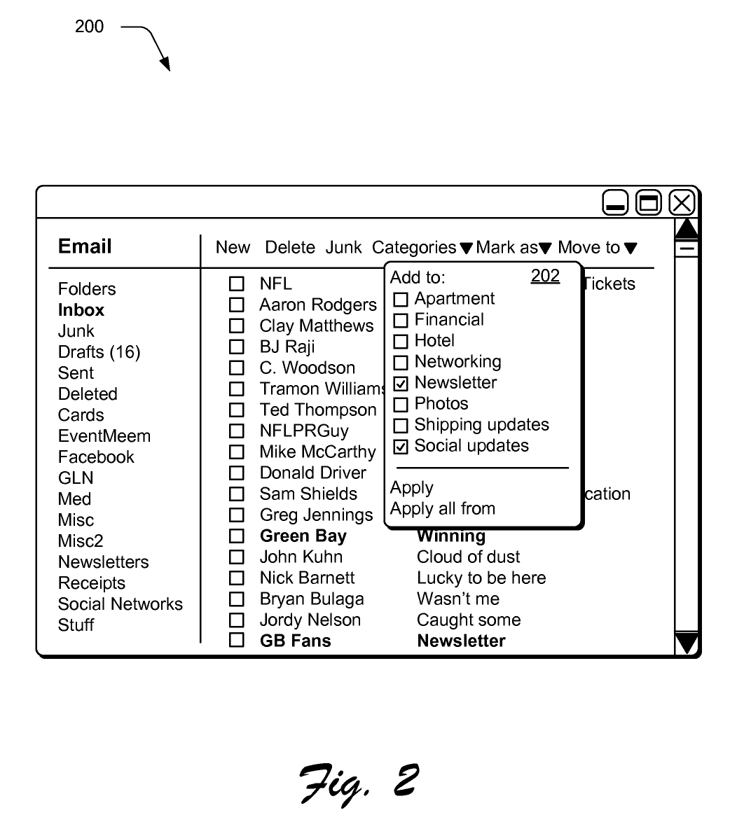

In the techniques described herein, however, a user may interact with the message manager module 112 to perform bulk categorization of messages. For example, the message manager module 112 may expose functionality via which a user may create a rule that applies one or more categories to each message received from a sender. This may include current messages stored in a user's account and/or messages received in the future. In this way, a user may efficiently categorize messages, further discussion of which may be found in relation to the example user interfaces beginning at FIG. 2.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

FIG. 2 is an illustration of a user interface 200 in an example implementation that exposes functionality to categorize one or more messages from one or more senders. The user interface 200 includes a list of folders on the left side of the user interface, with a folder “inbox” selected as depicted through use of bolding. Consequently, a center portion includes messages that are accessible through the inbox, which is below a menu of selectable items that includes “new,” “delete,” “junk,” “categories,” “mark as,” and “move to.”

The messages “Green Bay” and “GB Fans” are illustrated as being selected through use of bolding. The messages may be selected in a variety of ways, such as through use of a cursor control device (e.g., through two clicks while holding a control key), a tap gesture, and so on. In this example, each of the messages was sent by a different sender that originated the message, respectively.

A user may then select an option to categorize the messages, such as by selecting a “category” item from the menu above. Selection of this item causes output of a menu 202 (e.g., as a pop-up) having a listing of categories in which the selected messages may be classified. In the illustrated implementation, each category has a corresponding check box that is selectable by a user, e.g., using a cursor control device, gesture, voice command, and so on. Thus, a user may select one or more categories, in which, to classify the selected messages from the menu 202.

The menu 202 also includes an option to “apply” the categorization to the selection messages as well as an option to “apply all from” the corresponding senders. Selection of the “apply all from” option may be used to classify additional messages from the sender in a variety of ways. For example, selection of the option may be used to classify each of the messages in a current folder that is displayed in the user interface 200 (e.g., the inbox in this example), may be used to classify each of the messages from the sender in the user account that is accessed via the user interface 200, and so on. Further, another option may be output to classify subsequent messages that are received in the future by the user account, an example of which is shown in the following figure.

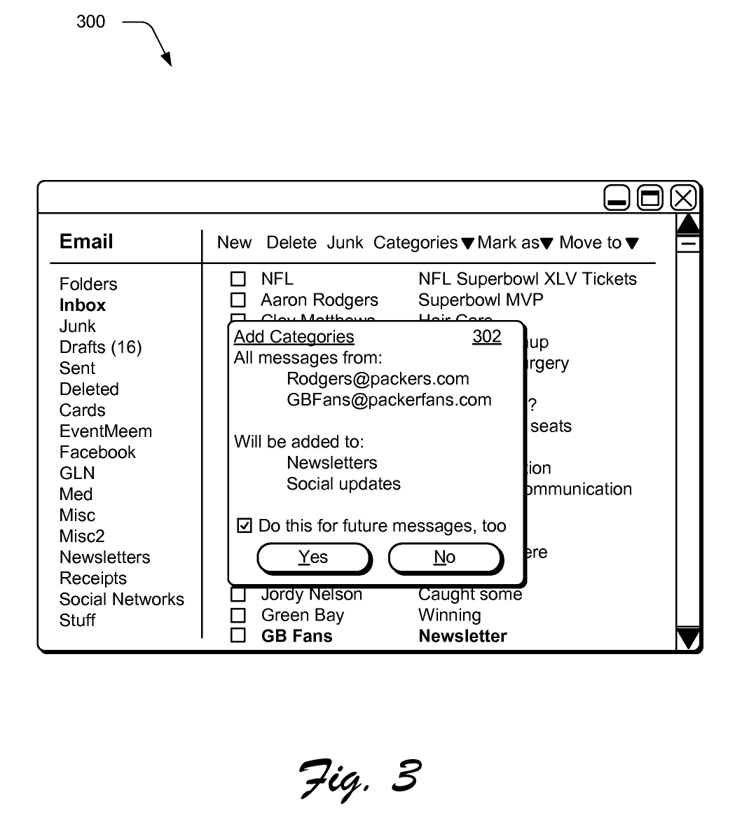

FIG. 3 illustrates a user interface 300 in which a menu includes an option to create a rule to classify subsequent messages for one or more senders selected via the user interface 200 of FIG. 2. In this user interface 300, another menu 302 is output in response to selection of the “apply all from” option in the menu 202 of FIG. 2.

This menu 302 includes text to confirm that messages from the senders are to be classified to the respective categories selected before. The menu 302 also includes an option to “do this for future messages, too.” Selection of this option may cause the message manager module 112 to create a rule to be applied to future messages from the senders. Thus, a user may efficiently categorize a single message, each message that currently resides in a user's account, and/or future messages from a user as desired.

For example, a user may select one or more messages and select “categories” from a menu 202 to select which categories are to be used to classify messages from the sender. To specify that each current message is to be classified for the selected sender, the user may select the “apply to all from” option. A user may also specify to perform this for subsequent messages received in the user's account through selection of “do this for future messages, too” option in the menu 302.

These actions may cause the message manager module 112 to search for each of the messages for each of the senders of the messages selected, apply the selected categories to each of the messages belonging to each sender selected, and create a rule to categorize subsequent messages from each sender that was selected. Thus, if a user selected ten messages with ten different senders and each sender having sent ten messages and specifies two categories, one hundred messages may be categorized along with twenty different rules created to be applied to future messages. Further discussion of bulk categorization techniques for messages may be found in relation to the following procedures.

Example Procedures

The following discussion describes message techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interfaces 200, 300 of FIGS. 2 and 3, respectively.

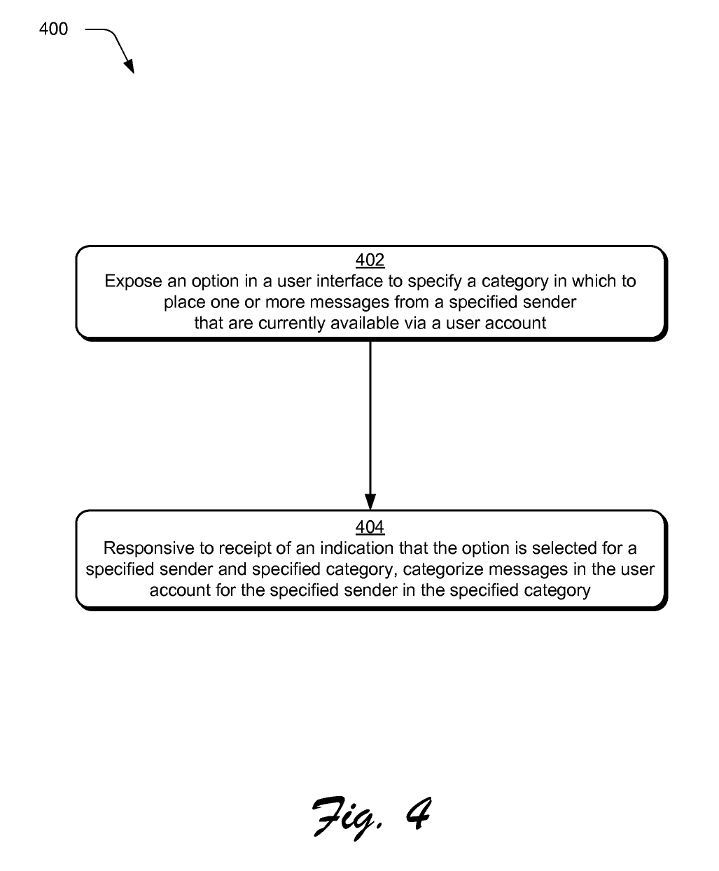

FIG. 4 depicts a procedure 400 in an example implementation in which an option is exposed to categorize messages received from a sender. An option is exposed in a user interface to specify a category in which to place one or more messages from a specified sender that are currently available via a user account (block 402). The option, for instance, may be configured to enable a user to select categories for messages and have those categories applied to each message from a sender of the selected messages as shown in FIG. 2.

Responsive to receipt of an indication that the option is selected for a specified sender and specified category, messages are categorized in the user account for the specified sender in the specified category (block 404). The message manager module 112, for instance, may categorize the messages according to the selections made in the previous example. This categorization may include moving the messages to a corresponding folder, enabling functionality that is specified to the category to be applied to those messages (e.g., to unsubscribe to a newsletter), and so on. Thus, in this example the categorization may be performed for messages that currently reside in a user's account. Similar functionality may also be implemented to categorize messages that are received in the future, an example of which is discussed in relation to the following figure.

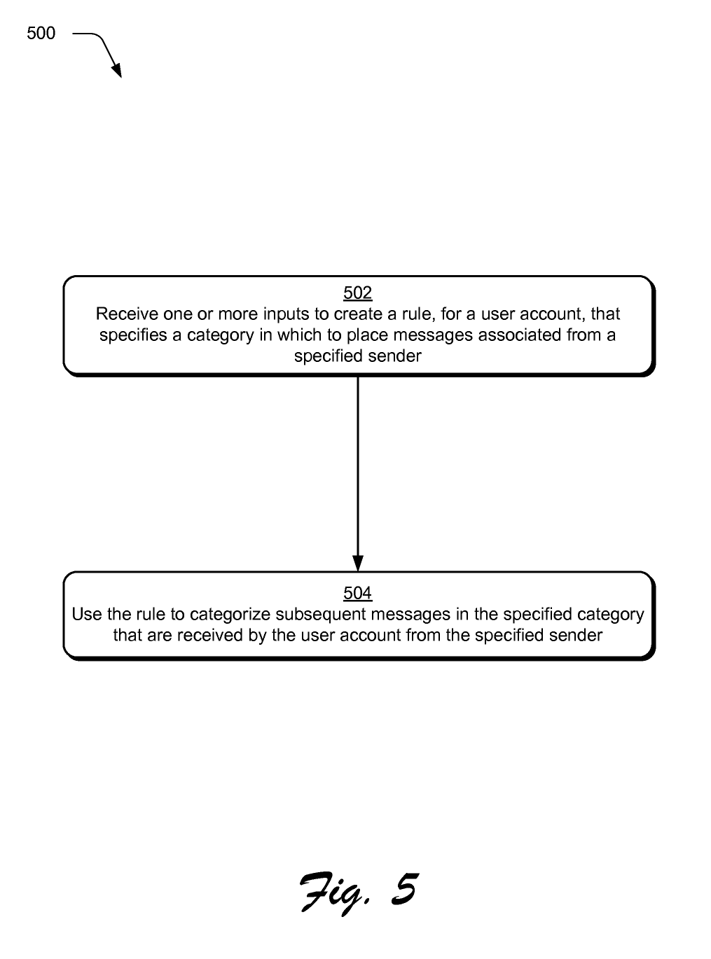

FIG. 5 depicts a procedure 500 in an example implementation in which a rule is created to categorize messages from a specified sender. One or more inputs are received to create a rule, for a user account, that specifies a category in which to place messages associated from a specified sender (block 502). The user, for instance, may select an option to “do this for future messages, too” as shown in the menu 302 of FIG. 3. This functionality may be implemented in a variety of other ways, such as included in the menu 202 of FIG. 2 along with the options to categorize, accessed through a macro (e.g., a key combination), a gesture, and so forth.

The rule is used to categorize subsequent messages in the specified category that are received by the user account from the specified sender (block 504). The rule, for instance, may be automatically created without further user intervention by the message manager module 112. This rule may then be utilized to automatically classify future messages into the specified categories. In one or more implementations, the message manager module 112 may support functionality to enable a user to access to rule to change, modify, or delete the rule. A variety of other examples are also contemplated.

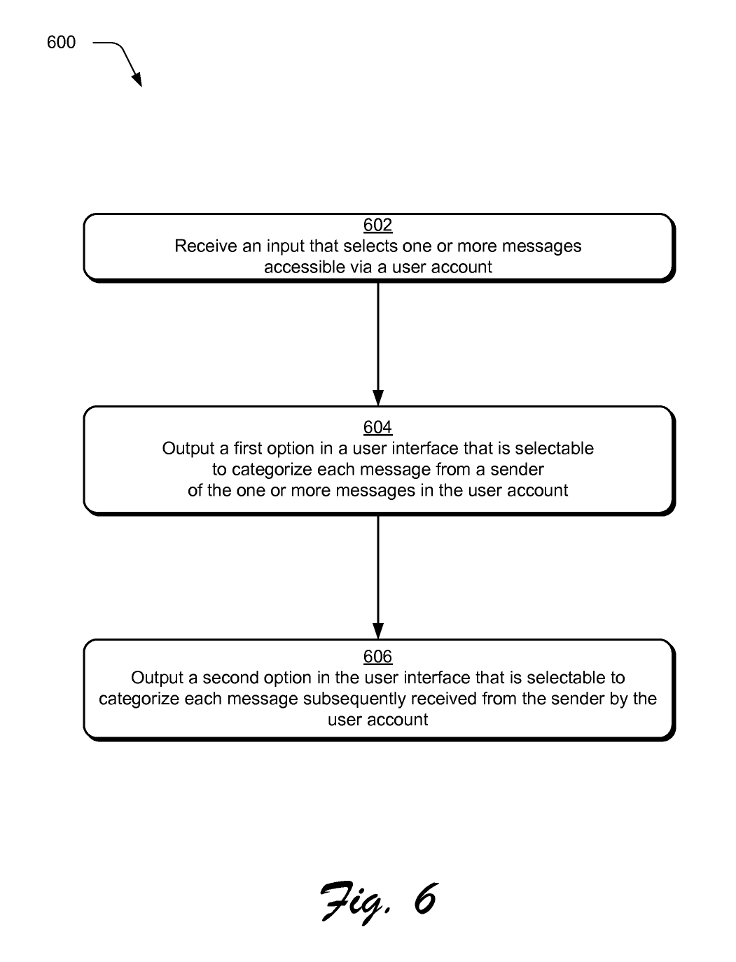

FIG. 6 depicts a procedure 600 in an example implementation in which options are output to categorize each message from a sender as well as subsequent messages received from the sender. An input is received that selects one or more messages accessible via a user account (block 602). A user, for instance, may select the messages from a plurality of senders, such as messages “GB Fans” and “Green Bay” as shown in the user interface 200 of FIG. 2.

A first option is output in a user interface that is selectable to categorize each message from a sender of the one or more messages in the user account (block 604). The menu 202 is illustrated as including an option “apply all from” to categorize messages received from the sender of the selected messages above as shown in the user interface 200 of FIG. 2.

A second option is output in the user interface that is selectable to categorize each message subsequently received from the sender by the user account (block 606). This second option, for instance, may include text to “do this for future messages, too” and a check box that is selectable as shown in the menu 302 of the user interface 300 of FIG. 3 to create a rule to categorize messages received in the future. Although emails were shown and discussed in relation to FIGS. 2 and 3, it should be readily apparent that a wide variety of different messaging techniques may incorporate the features described herein, examples of which include the following.

Communication Techniques

The following provides further examples of the communication techniques that may be employed to deliver a message to a client device 104 as well as transmit the message by the client device 104.

Instant Messaging

Instant messaging is a popular text-based communication tool that enables two or more users to exchange messages via a network during an instant messaging session. When two users are online at the same time, for instance, instant messages may be exchanged in real time between the two users. Thus, the instant messages may be utilized to support a text conversation between the two users in a manner that mimics how the two users would participate in a typical spoken conversation.

Instant messaging is typically based on clients that facilitate connections between specified known users. Often, these known users can be associated with a “buddy list” or “contact list.” Although instant messaging is text-based, instant messaging may include additional features such as audio and/or video. For example, during an instant messaging session, users can see each other by using webcams or other video cameras, and/or hear each other using microphones and speakers.

In an implementation, instant messaging (IM) modules communicate with each other through use of one or more of a plurality of service providers. A service provider, for instance, may include an IM manager module, which is executable to route instant messages between the IM modules. For example, a client may cause the IM module to form an instant message for communication to a recipient. The IM module is executed to communicate the instant message to the service provider, which then executes the IM manager module to route the instant message to the recipient over the network. The recipient receives the instant message and executes the IM module to display the instant message.

Clients can also be communicatively coupled directly, one to another (e.g., via a peer-to-peer network). If so, the instant messages are communicated without utilizing the service provider.

SMS/MMS

Short Messaging Service (SMS) is communication tool that allows an exchange of short text messages between a fixed line or mobile phone device and fixed or portable devices over a network. Unlike instant messaging, SMS messages can be transmitted without both the sender and receiver being simultaneously online. SMS messages may be sent to a Short Message Service Center (SMSC), which may provide a store and forward mechanism. The SMSC may then attempt to send the SMS messages to intended recipients. If a recipient cannot be reached, the SMSC may queue the SMS message and retry at a later time. Some SMSCs, however, may provide a forward and forget option where transmission is attempted only once. Both senders and recipients of SMS messages may be identified by a phone number associated with the device being used to send or receive the SMS message.

In addition to text, SMS techniques have been expanded to include Multimedia Messaging Service (MMS) which allows the exchange of multimedia content along with the short text messages. Multimedia content may include digital photographs, videos, and the like. Similar to SMS messages, MMS messages may identify senders and recipients by their respective phone numbers.

Although MMS messages are similar to SMS messages, MMS messages are delivered in an entirely different way. For example, the multimedia content in the MMS message is first encoded in a manner similar to a Multipurpose Internet Mail Extension (MIME) email. The encoded MMS message is then forwarded to a Multimedia Messaging Service Carrier (MMSC), which is a carrier's MMS store and forward server. If the intended recipient is associated with a different carrier, the MMSC may forward the encoded message to the recipient's carrier using the Internet.

Once the MMSC has received the message, it may determine whether the recipient's device is configured to receive an MMS message. If the recipient's device is MMS capable, then the content is extracted and sent to a temporary storage server with a Hypertext Transfer Protocol (HTTP) front-end. An SMS control message containing a Uniform Resource Locator (URL) of the MMS content may then be sent to the recipient's device to trigger the recipient device's Wireless Access Protocol (WAP) browser to open and receive the MMS content from the URL. If, however, the recipient device does not support MMS messages, the MMSC may attempt to modify the MMS content into a format suitable for the recipient device before sending the MMS content to the recipient device.

Electronic Mail

Electronic mail, commonly referred to as email or e-mail, is a communication tool for exchanging digital messages from an author to one or more recipients over a network. A user can send an email message through his or her email program, which sends the email message to a mail server. The mail server may then forward the email message to another mail server or to a message store on the same mail server to be forwarded later. Unlike instant messages or SMS/MMS messages, email messages may identify senders and recipients by addresses including user names and domain names.

Email messages include an envelope, a header, and a body. The header may include fields that have names and values. Some example fields include From, To, CC, Subject, Date, and other information about the email message. The body may include basic content of the email message, as unstructured text, and may also include a signature block. The envelope is used to store communication parameters for delivery of the email message.

Email is one of the protocols included with the Transport Control Protocol/Internet Protocol (TCP/IP) suite of protocols. An example popular protocol for sending email is Simple Mail Transfer Protocol (SMTP), whereas example popular protocols for receiving emails include Post Office Protocol 3 (POP3) and/or Internet Message Access Protocol (IMAP). TCP/IP can be used as a communication language or protocol of the Internet, an intranet, or extranet. When an email message is sent over a network, the TCP manages assembly of the message or file into smaller packets, also referred to as “packetizing” the message. These packets are transmitted over the network, such as the Internet, and received by a TCP layer that reassembles the packets into the original message. The IP layer handles the address portion of each packet to ensure that each packet reaches the correct destination.

Web Service

Electronic messages may also be sent and received via a web service. A web service may include a software system designed to support interoperable machine-to-machine interaction over a network. Implementations of web services include web-based email services and/or web-based IM services. Web based services may include Extensible Markup Language (XML) messages that follow a Simple Object Access Protocol (SOAP) standard. Other web services may include Web Application Programming Interfaces (Web API), which may include a set of HTTP request messages along with a definition of the structure of response messages.

Web services may be used in a number of ways. Some example uses include Remote Procedure Calls (RPC), Service-Oriented Architecture (SOA), and Representational State Transfer (REST).

Example System and Device

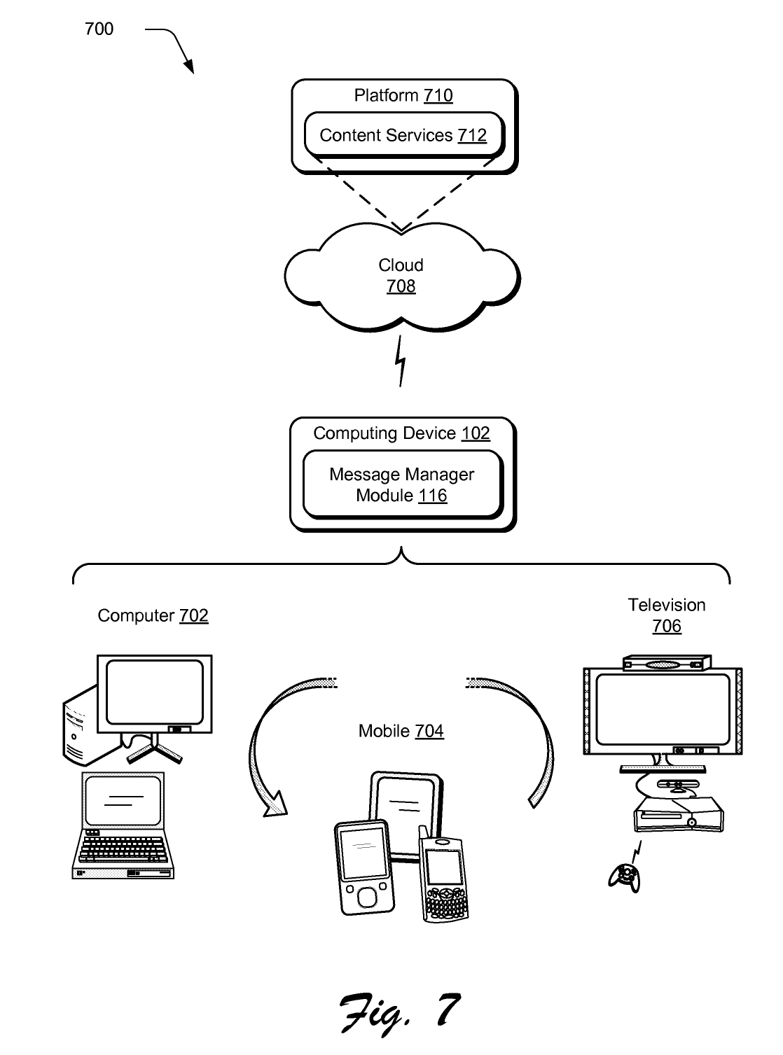

FIG. 7 illustrates an example system 700 that includes the client device 104 as described with reference to FIG. 1. The example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 702, mobile 704, and television 706 uses. Each of these configurations includes devices that may have generally different constructs and capabilities, and thus the computing device 102 may be configured according to one or more of the different device classes. For instance, the computing device 102 may be implemented as the computer 702 class of a device that includes a personal computer, desktop computer, a multi-screen computer, laptop computer, netbook, and so on.

The computing device 102 may also be implemented as the mobile 704 class of device that includes mobile devices, such as a mobile phone, portable music player, portable gaming device, a tablet computer, a multi-screen computer, and so on. The computing device 102 may also be implemented as the television 706 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein. Further, this functionality may also be distributed “over the cloud” as described below.

The cloud 708 includes and/or is representative of a platform 710 for content services 712. The platform 710 abstracts underlying functionality of hardware (e.g., servers) and software resources of the cloud 708. The content services 712 may include applications and/or data that can be utilized while computer processing is executed on servers that are remote from the computing device 102. Content services 712 can be provided as a service over the Internet and/or through a subscriber network, such as a cellular or Wi-Fi network.

The platform 710 may abstract resources and functions to connect the computing device 102 with other computing devices. The platform 710 may also serve to abstract scaling of resources to provide a corresponding level of scale to encountered demand for the content services 712 that are implemented via the platform 710. Accordingly, in an interconnected device embodiment, implementation of functionality of the functionality described herein may be distributed throughout the system 700. For example, the functionality may be implemented in part on the computing device 102 as well as via the platform 710 that abstracts the functionality of the cloud 708.

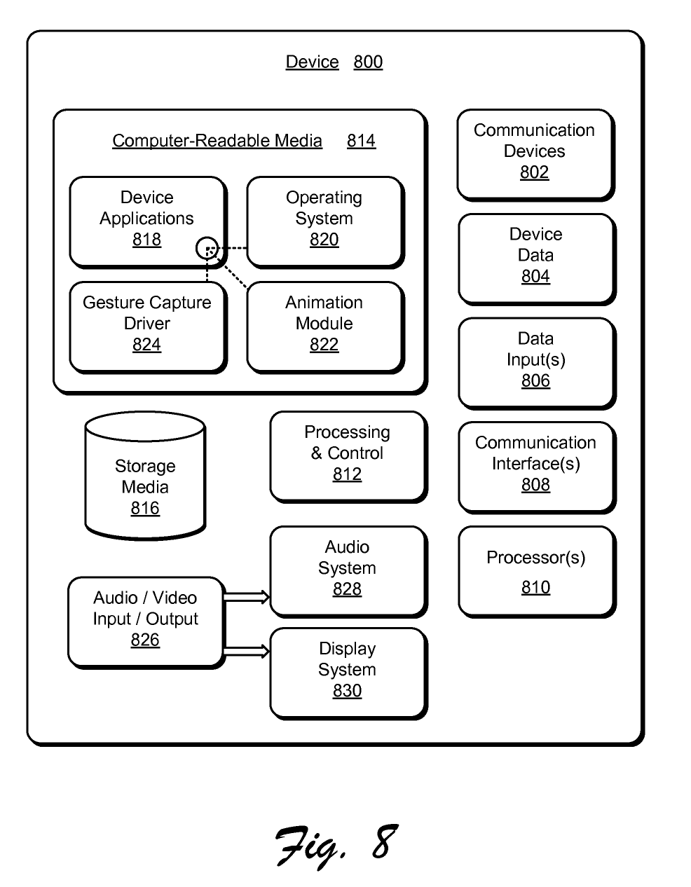

FIG. 8 illustrates various components of an example device 800 that can be implemented as any type of computing device as described with reference to FIGS. 1, 2, and 7 to implement embodiments of the techniques described herein. Device 800 includes communication devices 802 that enable wired and/or wireless communication of device data 804 (e.g., received data, data that is being received, data scheduled for broadcast, data packets of the data, etc.). The device data 804 or other device content can include configuration settings of the device, media content stored on the device, and/or information associated with a user of the device. Media content stored on device 800 can include any type of audio, video, and/or image data. Device 800 includes one or more data inputs 806 via which any type of data, media content, and/or inputs can be received, such as user-selectable inputs, messages, music, television media content, recorded video content, and any other type of audio, video, and/or image data received from any content and/or data source.

Device 800 also includes communication interfaces 808 that can be implemented as any one or more of a serial and/or parallel interface, a wireless interface, any type of network interface, a modem, and as any other type of communication interface. The communication interfaces 808 provide a connection and/or communication links between device 800 and a communication network by which other electronic, computing, and communication devices communicate data with device 800.

Device 800 includes one or more processors 810 (e.g., any of microprocessors, controllers, and the like) which process various computer-executable instructions to control the operation of device 800 and to implement embodiments of the techniques described herein. Alternatively or in addition, device 800 can be implemented with any one or combination of hardware, firmware, or fixed logic circuitry that is implemented in connection with processing and control circuits which are generally identified at 812. Although not shown, device 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 800 also includes computer-readable media 814, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 800 can also include a mass storage media device 816.

Computer-readable media 814 provides data storage mechanisms to store the device data 804, as well as various device applications 818 and any other types of information and/or data related to operational aspects of device 800. For example, an operating system 820 can be maintained as a computer application with the computer-readable media 814 and executed on processors 810. The device applications 818 can include a device manager (e.g., a control application, software application, signal processing and control module, code that is native to a particular device, a hardware abstraction layer for a particular device, etc.). The device applications 818 also include any system components or modules to implement embodiments of the techniques described herein. In this example, the device applications 818 include an interface application 822 and an input/output module 824 that are shown as software modules and/or computer applications. The input/output module 824 is representative of software that is used to provide an interface with a device configured to capture inputs, such as a touchscreen, track pad, camera, microphone, and so on. Alternatively or in addition, the interface application 822 and the input/output module 824 can be implemented as hardware, software, firmware, or any combination thereof. Additionally, the input/output module 824 may be configured to support multiple input devices, such as separate devices to capture visual and audio inputs, respectively.

Device 800 also includes an audio and/or video input-output system 826 that provides audio data to an audio system 828 and/or provides video data to a display system 830. The audio system 828 and/or the display system 830 can include any devices that process, display, and/or otherwise render audio, video, and image data. Video signals and audio signals can be communicated from device 800 to an audio device and/or to a display device via an RF (radio frequency) link, S-video link, composite video link, component video link, DVI (digital video interface), analog audio connection, or other similar communication link. In an embodiment, the audio system 828 and/or the display system 830 are implemented as external components to device 800. Alternatively, the audio system 828 and/or the display system 830 are implemented as integrated components of example device 800.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
exposing an option in a user interface to specify a category in which to place one or more messages associated with a user account from a specified sender; and
responsive to receipt of an indication that the option is selected for a specified sender and specified category, categorizing messages in the user account for the specified sender in the specified category.

2. A method as described in claim 1, further comprising exposing another option in the user interface to specify that the category is to be used to place subsequent messages received from the specified sender at the user account.

3. A method as described in claim 1, wherein the option that is exposed to specify the category is selectable via a single click in the user interface.

4. A method as described in claim 1, wherein the category is at least one of a newsletter, transaction, confirmation, travel document, or receipt.

5. A method as described in claim 1, wherein the one or more computing devices implement a network service via which the user account is accessible via a network.

6. A method as described in claim 1, wherein the exposing is performed responsive to selecting one or more messages from the sender in the user interface.

7. A method as described in claim 1, wherein the exposing is performed for a plurality of said senders.

8. A method as described in claim 1, wherein the message is an email, a SMS text, a MMS text, or an instant message.

9. A method implemented by one or more computing devices, the method comprising:
receiving one or more inputs to create a rule, for a user account, that specifies a category in which to place messages associated from a specified sender; and
using the rule to categorize subsequent messages in the specified category that are received by the user account from the specified sender.

10. A method as described in claim 9, further comprising receiving one or more other inputs to specify the category in which to place one or more messages currently associated with the user account from the specified sender.

11. A method as described in claim 9, wherein the one or more inputs are received through selection of an option that is selectable via a single click in the user interface.

12. A method as described in claim 9, wherein the category is at least one of a newsletter, transaction, confirmation, travel document, or receipt.

13. A method as described in claim 9, wherein the one or more computing devices implement a network service via which the user account is accessible via a network.

14. A method as described in claim 9, wherein the receiving is performed responsive to interaction with a user interface that is exposed responsive to selection of one or more messages from the sender.

15. A method as described in claim 9, wherein the receiving and the using are performed for a plurality of said senders.

16. A method as described in claim 9, wherein the messages are configured as an email, a SMS text, a MMS text, or an instant message.

17. A method implemented by one or more computing devices, the method comprising:
receiving an input that selects one or more messages accessible via a user account;
outputting a first option in a user interface that is selectable to categorize each message from a sender of the one or more messages in the user account; and
outputting a second option in the user interface that is selectable to categorize each message subsequently received from the sender by the user account.

18. A method as described in claim 17, wherein the first and second options are selectable via the user interface to perform corresponding said categorization for a plurality of said senders.

19. A method as described in claim 17, wherein the outputting of the first and second options is performed concurrently in the user interface.

20. A method as described in claim 17, wherein the second option is selectable to create a rule.
